(19) United States
(12) Patent Application Publication
(10) Pub. No.: US 2013/0225404 A1
(43) Pub. Date: Aug. 29, 2013

(54) PESTICIDAL COMBINATIONS

(71) Applicants: Christoph Grimm, Stein (CH); Michael Schade, Basel (CH); Andreas Zoschke, Basel (CH); Beat Reber, Stein (CH)

(72) Inventors: Christoph Grimm, Stein (CH); Michael Schade, Basel (CH); Andreas Zoschke, Basel (CH); Beat Reber, Stein (CH)

(73) Assignee: SYNGENTA PARTICIPATIONS AG, Basel (CH)

(21) Appl. No.: 13/883,281

(22) PCT Filed: Oct. 19, 2011
(86) PCT No.: PCT/EP11/68277

§ 371 Date: May 13, 2013

(30) Foreign Application Priority Data
Nov. 2, 2010 (EP) 10189664.5

(51) Int. Cl. A01N 51/00; A01N 25/32

(52) U.S. Cl. CPC A01N 51/00; A01N 25/32
USPC 504/100; 514/229.2; 514/155; 47/58.1 SE

(57) ABSTRACT

The present invention relates to the composition comprising a neonicotinoid insecticide selected from: imidacloprid, clothianidin and thiamethoxam and a metabolic herbicide safener. The composition is of particular use in the treatment of plant propagation material (preferably seeds) and improves the growing characteristics of a plant and/or prevents from unwanted plant damage caused by herbicides.

The present invention relates to the use in agriculture of a composition comprising a neonicotinoid insecticide and a metabolic herbicide safener. The composition is of particular use in the treatment of plant propagation material, more specifically seeds and improves the growing characteristics of a plant. The invention encompasses the compositions per se, as well as methods of their use for the control or prevention of unwanted plant damage caused by herbicides, especially in the agricultural field.

The combination of a neonicotinoid insecticide and a herbicide safener is known from WO2006/008110. In WO2006/008110 many combinations are suggested which are reported to provide an improved insecticidal efficacy of the neonicotinoids when the combination is applied onto the leaves of Brassica plants.

It has now been found that a particular combination of a metabolic herbicide safener and a neonicotinoid insecticide suitable for seed treatment provides for an improved safening of the plant against herbicide application to a plant propagation material, in particular when the combination is applied to the seed. Thus in a first aspect the invention provides a composition suitable for treating seeds, the composition comprisinga metabolic herbicide safener and a neonicotinoid insecticide selected from imidacloprid, clothianidin and thiamethoxam, wherein the total amount of herbicide safener and neonicotinoid is from 0.5 wt % and 99 wt %, based on the total weight of the composition. Preferably the composition additionally comprises water.

Although the composition of the invention may be applied to any plant propagation material, it is particularly suitable for application to a seed. It has been found that applying a metabolic herbicide safener and a neonicotinoid suitable for seed treatment to a seed provided improved properties to the plant propagation material, in particular to the seed but also to the germinated seed and growing plant. The improved properties include safening the plant propagation material against an applied herbicide, improving the insecticidal efficacy of the neonicotinoid, increasing general abiotic stress resistance (e.g. salinity and pH of the soil, temperature, drought), and in particular cold stress resistance, reducing the lateral mobility of the neonicotinoid in the field, improving root mass, enhancing the uptake of plant nutrients and water by the plant propagation material, improving early crop establishment and growth, and increasing yield. The application of the combination of the invention to seeds generally also enables a better weed control. It may allow for a higher application rate of the herbicide or for the use of (less- or non-selective) herbicides that would normally be detrimental to the crop—whether applied to the soil, as a foliar spray, or in furrow—thus resulting in better weed control, including weeds that are hard to control, like Bromus, for example. Furthermore, such an application may enable a reduction in the amount of herbicide safener typically present in conventional herbicide formulations, thus potentially resulting in less safening of the weeds and an improved herbicidal efficacy.

Neither of these benefits were demonstrated in the above-mentioned WO 2006/008110, wherein the focus of the application clearly is directed to insecticidal efficacy combined with a foliar application of the neonicotinoid and herbicide safener.

The total weight of the neonicotinoid and metabolic herbicide safener in the composition of the invention is generally between 0.5 and 99 wt %, based on the total weight of the composition. The total amount is preferably between 1 and 95 wt %, more preferably between 5 and 80 wt %, even more preferably between 10 and 70 wt %, and most preferably between 15 and 60 wt %, based on the total weight of the composition.

The wording “metabolic herbicide safener” refers to a herbicide safener that stimulates the metabolism of a herbicide by the plant propagation material and, as the skilled man will appreciate, any plant material generated therefrom Examples of suitable herbicide safeners include AD67, BAS 145138, benoxacor, cloquintocet-mexyl, cyprosulfamide, dichlormid, fenchlorazole-ethyl, flurazole, fluxofenim, MG 191, naphthalene anhydride, mefenpyr-methyl, isoxadifen, oxabetrinil, fenclorim, mefenpyr and N-(2-methoxybenzoyl)-4-[(methylaminocarbonyl)amino]benzenesulfonamide.

In one embodiment of the invention, the metabolic herbicide safener is one which acts by stimulating the production of glutathione-S-transferase (GST) in the plant propagation material/plant material generated therefrom Examples of such herbicide safeners include AD67, BAS 145138, benoxacor, cloquintocet-mexyl, cyprosulfamide, dichlormid, fenchlorazole-ethyl, flurazole, fluxofenim, MG 191, oxabetrinil, naphthalene anhydride, and N-(2-methoxybenzoyl)-4-[(methylaminocarbonyl)amino]benzenesulfonamide.

Preferably, the metabolic herbicide safener acting via GST is benoxacor, dichlormid, cyprosulfamide, fluxofenim or N-(2-methoxybenzoyl)-4-[(methylaminocarbonyl)amino]-benzenesulfonamide.

More preferably the metabolic herbicide is benoxacor, dichlormid, cyprosulfamide, or N-(2-methoxybenzoyl)-4-[(methylaminocarbonyl)amino]benzenesulfonamide.

More preferably still, the metabolic herbicide safener is benoxacor, cyprosulfamide or N-(2-methoxybenzoyl)-4-[(methylaminocarbonyl)amino]benzenesulfonamide. Most preferably, the herbicide safener is benoxacor or N-(2-methoxybenzoyl)-4-[(methylaminocarbonyl)amino]-benzenesulfonamide.

Combinations of two or more of the above-mentioned herbicide safeners are also contemplated for use in the compositions of the invention.

The neonicotinoid insecticide of the invention is selected from thiamethoxam, clothianidin and imidacloprid. Preferably, the neonicotinoid is thiamethoxam. In one embodiment of the invention the neonicotinoid insecticide used in the composition of the invention is a mixture of neonicotinoid insecticides, e.g. a mixture of thiamethoxam and imidacloprid, a mixture of thiamethoxam and clothianidin, a mixture of clothianidin and imidacloprid, or even a three-way mixture of thiamethoxam, clothianidin and imidacloprid.

In specific embodiments compositions of the invention comprise the following combinations of (I) neonicotinoid insecticide and (II) metabolic herbicide safener, optionally in combination with one or more customary formulation auxiliaries: (I) thiamethoxam and (II) benoxacor; (I) thiamethoxam and (II) N-(2-methoxybenzoyl)-4-[(methylaminocarbonyl)amino]-benzenesulfonamide; (I) thiamethoxam and (II) cloquintocet-mexyl; (I) thiamethoxam and (II) dichlormid; (I) thiamethoxam and (II) cyprosulfamid, (I) thiamethoxam and (II) fluxofenim.

In further embodiments of the invention the combination may be any of the above combinations except that thiamethoxam is replaced by either imidacloprid or clothianidin, or by a mixture of two or three of thiamethoxam, imidacloprid and clothianidin i.e. thiomethoxam in the above combinations may be replaced by a combination of thiomethoxam and clothianidin, or by a combination of thiomethoxam and imidacloprid, or by a combination of clothianidin and imidacloprid, or by a combination of thiomethoxam, clothianidin, and imidacloprid.

The combinations of neonicotinoid insecticide and metabolic herbicide safeners specified above are novel. Accordingly the invention further extends to the following mixtures of (I) neonicotinoid insecticide and (II) metabolic herbicide safener: (I) thiamethoxam and (II) benoxacor; (I) thiamethoxam and (II) N-(2-methoxybenzoyl)-4-[(methylaminocarbonyl)amino]-benzenesulfonamide; (I) thiamethoxam and (II) cloquintocet-mexyl; (I) thiamethoxam and (II) dichlormid; (I) thiamethoxam and (II) cyprosulfamid; (I) thiamethoxam and (II) fluxofenim; (I) clothianidin and (II) benoxacor; (I) clothianidin and (II) N-(2-methoxybenzoyl)-4-[(methylaminocarbonyl)amino]benzenesulfonamide; (I) clothianidin and (II) cloquintocet-mexyl; (I) clothianidin and (II) dichlormid; (I) clothianidin and (II) cyprosulfamid; (I) clothianidin and (II) fluxofenim; (I) imidacloprid and (II) benoxacor; (I) imidacloprid and (II) N-(2-methoxybenzoyl)-4-[(methylaminocarbonyl)amino]benzenesulfonamide; (I) imidacloprid and (II) cloquintocet-mexyl; (I) imidacloprid and (II) dichlormid; (I) imidacloprid and (II) cyprosulfamid; (I) imidacloprid and (II) fluxofenim; (I) thiamethoxam and clothianidin and (II) benoxacor; (I) thiamethoxam and clothianidin and (II) N-(2-methoxybenzoyl)-4-[(methylaminocarbonyl)amino]benzenesulfonamide; (I) thiamethoxam and clothianidin and (II) cloquintocet-mexyl; (I) thiamethoxam and clothianidin and (II) dichlormid; (I) thiamethoxam and clothianidin and (II) cyprosulfamid; (I) thiamethoxam and clothianidin and (II) fluxofenim; (I) clothianidin and imidacloprid and (II) benoxacor; (I) clothianidin and imidacloprid and (II) N-(2-methoxybenzoyl)-4-[(methylaminocarbonyl)amino]benzenesulfonamide; (I) clothianidin and imidacloprid and (II) cloquintocet-mexyl; (I) clothianidin and imidacloprid and (II) dichlormid; (I) clothianidin and imidacloprid and (II) cyprosulfamid; (I) clothianidin and imidacloprid and (II) fluxofenim; (I) thiamethoxam and imidacloprid and (II) benoxacor; (I) thiamethoxam and imidacloprid and (II) N-(2-methoxybenzoyl)-4-[(methylaminocarbonyl)amino]-benzenesulfonamide; (I) thiamethoxam and imidacloprid and (II) cloquintocet-mexyl; (I) thiamethoxam and imidacloprid and (II) dichlormid; (I) thiamethoxam and imidacloprid and (II) cyprosulfamid; (I) thiamethoxam and imidacloprid and (II) fluxofenim; (I) thiamethoxam, clothianidin, and imidacloprid and (II) benoxacor; (I) thiamethoxam, clothianidin, and imidacloprid and (II) N-(2-methoxybenzoyl)-4-[(methylaminocarbonyl)amino]-benzenesulfonamide; (I) thiamethoxam, clothianidin, and imidacloprid and (II) cloquintocet-mexyl; (I) thiamethoxam, clothianidin, and imidacloprid and (II) dichlormid; (I) thiamethoxam, clothianidin, and imidacloprid and (II) cyprosulfamid; (I) thiamethoxam, clothianidin, and imidacloprid and (II) fluxofenim.

Compositions and/or mixtures of the invention as described herein may also comprise a further agrochemical compound. The agrochemical compound may be an insecticide, a nematicide, a fungicide, a herbicide or any other suitable agrochemical compound e.g. a plant growth regulator, phytohormone, and the like. The inclusion of such further agrochemical compounds may be for any suitable reason, for example, it may confer a broader spectrum of activity or control (e.g. against a wider variety of pests, diseases, unwanted plants etc.), it may facilitate lower use/application rates, it may provide for a suitable synergistic effect and/or it may be economically propitious to do so.

Preferred agrochemical compounds for inclusion in compositions/mixture of the invention are those which show systemic or mesostemic properties, i.e. those compounds which are transported within the plant to different loci of the plant.

In one embodiment,the agrochemical compound is an insecticide, a nematicide and/or a fungicide. Particularly preferred compounds are nematicides or insecticides.

In a further embodiment, the composition of the invention comprises a further insecticide which is selected from the group consisting of other neonicotinoids different from the neonicotinoids used in the composition of the invention, carbamates, diamides, spinosyns, phenylpyrazoles, pyrethroids and sulfoxaflor. Examples of such other neonicotinoids are acetamiprid, dinotefuran, nitenpyram and thiacloprid. Preferred neonicotinoids are thiamethoxam, imidacloprid and clothianidin. Examples of carbamates include thiodicarb, aldicarb, carbofuran, furadan, fenoxycarb, carbaryl, sevin, ethienocarb, and fenobucarb. Examples of diamides include chlorantraniliprole, cyantraniliprole, and flubendiamide. Examples of spinosyns include spinosad and spinetoram. Examples of pyrethoids include lambda-cyhalothrin, gamma-cyhalothrin, and tefluthrin. An example of a phenylpyrazole is fipronil.

In a further aspect of the invention the additional agrochemical compound is a nematicide. The nematicide can be any nematicide or nematicidally active compound known in the art. Examples include an avermectin (e.g. abamectin), carbamate nematicides (e.g., aldicarb, thiodicarb, carbofuran, carbosulfan, oxamyl, aldoxycarb, ethoprop, methomyl, benomyl, alanycarb, iprodione), organophosphorus nematicides (e.g., phenamiphos (fenamiphos), fensulfothion, terbufos, fosthiazate, dimethoate, phosphocarb, dichlofenthion, isamidofos, fosthietan, isazofos ethoprophos, cadusafos, terbufos, chlorpyrifos, dichlofenthion, heterophos, isamidofos, mecarphon, phorate, thionazin, triazophos, diamidafos, fosthietan, phosphamidon, imicyafos), and certain fungicides, such as captan, thiophanate-methyl and thiabendazole. Also included as a nematicide is a compound of formula X,

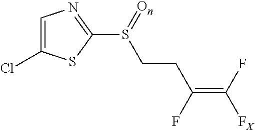

wherein n is 0, 1 or 2 and the thiazole ring may be optionally substituted. Abamectin, aldicarb, thiodicarb, dimethoate, methomyl, a compound of formula X and oxamyl are preferred nematicides for use in this invention. The most preferred nematicide is abamectin.

In another embodiment of the invention, the agrochemical compound is a nematicidally active biological organism which is a bacterium or a fungus. Preferably, the biological organism is a bacterium. Examples of nematicidally active bacteria include Bacillus firmus, Bacillus subtilis, Bacillus cereus, Streptomyces spp., and Pasteuria spp. Examples of a preferred nematicidally active fungus include those from the genus Pochonia and especially the species Pochonia chlamydosporia.

Suitable Bacillus firmus strains include strain CNCM 1-1582 which is commercially available as BioNem™, strain ATCC 8247, ATCC 14575, NCIMB 13289, NCTC 6354, CN 2936, and ATCC 14414. It was found that strains ATCC 8247, ATCC 14575, NCIMB 13289, NCTC 6354, CN 2936, and ATCC 14414 exhibit nematicidal efficacy, which render these strains suitable for the present invention. Suitable Bacillus cereus strains include strain CNCM 1-1562, strain ATCC 14579 and strain ATCC 10987. It was found that strains ATCC 14579 and ATCC 10987 exhibit nematicidal efficacy, which render these strains suitable for the present invention. Further details relating to Bacillus strains CNCM 1-1582 and CNCM I-1562 may be found in U.S. Pat. No. 6,406,690.

Suitable Streptomyces spp strains include Streptomyces strains capable of producing macrocyclic substances such as the bacterium Streptomyces avermitilis. Specific examples of Streptomyces strains are strain NRRL 8165, strain ATCC 31267, strain ATCC 31271, strain ATCC 31272, NRRL 5739, NC1B 11876, NC1B 11877, and NC1B 11878. Strains capable of producing avermectins, in particular abamectin, are further preferred, and these include a Streptomyces avermitilis strain selected from strain NRRL 8165, strain ATCC 31267, strain ATCC 31271, and strain ATCC 31272. Further examples and more details of suitable

Streptomyces strains can be found in GB 2,122,089.

Suitable Pasteuria spp strains include Pasteuria penetrans and Pasteuria nishizawae

In another embodiment of the invention the agrochemical is a fungicide, or a combination of an insecticide and a fungicide. The fungicide is preferably selected from azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (also known as mefenoxam), amisulbrom, ametoctradin, boscalid, fluopyram, ilsotianil, penflufen, penthiopyrad, proquianazid, sedaxane, and penflufen.

The skilled man would appreciate that certain individual agrochemical compounds may have activity in more than one area of pest control, e.g. a pesticide may have fungicide, insecticide and nematicide activity. Specifically, aldicarb is known to have insecticide, acaricide and nematicide activity, whilst metam is known to posess insecticidal, herbicidal, fungicidal and nematicidal activity. Both thiabendazole and captan can provide for nematicidal as well as fungicidal activity. Such agrochemical compounds are particularly suitable for inclusion in compositions and mixtures of the invention.

Each composition and/or mixture described herein may demonstrate a synergistic activity compared to the activity of the individual ingredients within the composition and/or mixture.

Further, in an embodiment the present invention relates to a method which comprises (i) treating a plant propagation material, such as a seed, with a composition as defined in the first aspect, and (ii) planting or sowing the treated propagation material, wherein the composition protects against pest damage of the treated plant propagation material, or part of plant, plant organ and/or plant grown from the treated propagation material. Preferably, the plant propagation material is a seed.

In an embodiment of the invention, the process further comprises the step of applying a agrochemical compound to the treated plant propagation material and/or its surroundings before or after the plant propagation material was planted or sown. The agrochemical compound can be any agrochemical compound suitable known in the art, in particular those agrochemical compounds which are applied as a soil treatment or as a foliar treatment. Such agrochemical compound can be, for instance, a pesticide, a fertilizer or a plant growth regulator. Preferably, the agrochemical compound is a pesticide, in particular a pesticide selected from a herbicide, a fungicide, an insecticide and a nematicide. In a particular embodiment of the invention the agrochemical compound is a pesticide which in general is phytotoxic to the plant propagation material. The composition of the invention considerably reduces or even completely diminishes the negative (i.e. phytotoxic) effects of such a pesticide on the plant propagation material. In one embodiment, the invention pertains to a method which comprises (i) treating a plant propagation material, such as a seed, with a composition as defined in the first aspect, and (ii) planting or sowing the treated propagation material, wherein the composition protects against pest damage of the treated plant propagation material, or part of plant, plant organ and/or plant grown from the treated propagation material. Preferably, the plant propagation material is a seed, wherein the process further comprises the step of applying a herbicide to the treated plant propagation material and/or its surroundings before or after the plant propagation material was planted or sown. An example of such a process is the application of clodinafop to rice plants of which the seeds were treated with N-(2-methoxybenzoyl)-4-[(methylaminocarbonyl)amino]benzenesulfonamide or cyprosulfamid.

The invention further pertains to a plant propagation material, preferably a seed, treated with the composition and/or combination of the invention.

Controlling, preventing or protecting and its inflections, within the context of the present invention, mean reducing any undesired effect, such as that caused by infestation or attack, and/or any damage by a pest on a plant, part of the plant or plant propagation material to such a level that an improvement is demonstrated.

Each composition and/or combination according to the invention has very advantageous properties for protecting plants against, for example, (i) pathogenic, such as phytopathogenic attack or infestation, which result in disease and damage to the plant and/or (ii) insect or nematode attack or damage; particularly in the instance of plants, the present invention can control or prevent the pest damage on a seed, or parts of plant, plant organs and/or plants. Further, a combination according to the invention, in the absence of pathogenic or insect and/or nematode pressure, improves the growth of a plant.

These properties are for example the synergistically enhanced actions of composition and/or combinations compared to the individual ingredients of the composition and/or combination (e.g. (I), and (II)), resulting in, for example, lower pathogenic pest damage, lower rates of application, or a longer duration of action. In the instance of agriculture, the enhanced actions are found to show an improvement in the growing characteristics of a plant by, for example, higher than expected control of the pest damage, or higher than expected yield, stand establishment, germination, etc.

The improvement in the growing (or growth) characteristics of a plant can manifest in a number of different ways, but ultimately it results in a better product of the plant. It can, for example, manifest in improving the yield and/or vigour of the plant or quality of the harvested product from the plant, which improvement may not be connected to the control of pests, such as fungi, insects and nematodes.

As used herein the phrase “improving the yield” of a plant relates to an increase in the yield of a product of the plant by a measurable amount over the yield of the same product of the plant produced under the same conditions, but without the application of the subject method. It is preferred that the yield be increased by at least about 0.5%, more preferred that the increase be at least about 1%, even more preferred is about 2%, and yet more preferred is about 4%, or more. Yield can be expressed in terms of an amount by weight or volume of a product of the plant on some basis. The basis can be expressed in terms of time, growing area, weight of plants produced, amount of a raw material used, or the like.

As used herein the phrase “improving the vigour” of a plant may include an increase or improvement of the vigour rating, or the stand (the number of plants per unit of area), or the plant height, or the plant canopy, or the visual appearance (such as greener leaf colour), or the root rating, or emergence, or protein content, or increased tillering, or bigger leaf blade, or less dead basal leaves, or stronger tillers, or less fertilizer needed, or less seeds needed, or more productive tillers, or earlier flowering, or early grain maturity, or less plant verse (lodging), or increased shoot growth, or earlier germination, or any combination of these factors, or any other advantages familiar to a person skilled in the art, by a measurable or noticeable amount over the same factor of the plant produced under the same conditions, but without the application of the subject method.

When it is said that the present method is capable of “improving the yield and/or vigour” of a plant, the present method results in an increase in either the yield, as described above, or the vigor of the plant, as described above, or both the yield and the vigor of the plant.

Accordingly, the present invention also provides a method of improving the growing characterictics of a plant, which comprises applying to the plant, part of plant, and/or plant propagation material, the ingredients of the combination, as defined in the first aspect, in any desired sequence or simultaneously, especially in the absence of pathogenic or pests pressure.

Each of the compositions and/or combinations of the invention can be used in the agricultural sector and related fields of use for controlling or preventing damage by pests, such as insect, nematode and pathogen, and/or controlling and/or preventing damage by herbicides to the plant propagation material, and hence aid in improved weed control, especially in the agricultural field.

Each of the compositions and/or combinations according to the present invention is effective against pest control, such as control of pests selected from Nematoda, Insecta and Arachnida. In that instance, the composition and/or combination can also be applied on the pest to control or prevent pest damage and protect the desired material (e.g. plant and part of plant) from pest damage. Examples of pests include: from the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseo/a fusca, Cadra cautella, Carposina nipponensis, Chilo spp., Choristoneura spp., Clysia ambiguella, Cnapha/ocrocis spp., Cnephasia spp., Cochylis spp., Coleophora spp., Crocido/omia spp., Cryptophlebia leucotreta, Crysodeixis includens, Cydia spp., Diatraea spp., Diparopsis castanea, Earias spp., Elasmopalpus spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiella, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusiani and Yponomeuta spp.; from the order Coleoptera, for example, Agriotes spp., Anthonomus spp., Atomaria linearis, Chrysomelidae, Ceutorhynchus spp., Chaetocnema tibialis, Cosmopolites spp., Curculio spp., Dermestes spp., Diabrotica spp., Diloboderus spp., Epilachna spp., Eremnus spp., Gonocephalum spp., Heteronychus spp., Leptinotarsa decemlineata, Lissorhoptrus spp., Melolontha spp., Orycaephilus spp., Otiorhynchus spp., Phlyctinus spp., Phyllotreta spp., Popillia spp., Protostrophus spp., Psylliodes spp., Rhizopertha spp., Scarabeidae, Sitophilus spp., Sitotroga spp., Sternechus spp., Tenebrio spp., Tribolium spp. and Trogoderma spp.; from the order Orthoptera, for example, Blatta spp., Blattella spp., Gryllotalpa spp., Leucophaea maderae, Locusta spp., Periplaneta spp. and Schistocerca spp.; from the order Isoptera, for example, Reticulitermes spp.; from the order Psocoptera, for example, Liposcelis spp.; from the order Anoplura, for example, Haematopinus spp., Linognathus spp., Pediculus spp., Pemphigus spp. and Phylloxera spp.; from the order Mallophaga, for example, Damalinea spp. and Trichodectes spp.; from the order Thysanoptera, for example, Frankliniella spp., Hercinothrips spp., Megalurothrips spp., Taeniothrips spp., Thrips spp., in particular Thrips palmi, and Thrips tabaci, and Scirtothrips aurantii; from the order Heteroptera, for example, Dichelops melacanthus, Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.; from the order Homoptera, for example, Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nasonovia spp., Nephotettix spp., Nilaparvata spp., Paratoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; from the order Hymenoptera, for example, Acromyrmex, Athalia rosae, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; from the order Diptera, for example, Antherigona soccata, Bibio hortulanus, Ceratitis spp., Chrysomyia spp., Culex spp., Cuterebra spp., Dacus spp., Delia spp., Drosophila melanogaster, Liriomyza spp., Melanagromyza spp., Orseolia spp., Oscinella frit, Pegomyia hyoscyami, Phorbia spp., Rhagoletis pomonella, Sciara spp.; from the order Acarina, for example, Acarus siro, Aceria sheldoni, Aculus schlechtendali, Amblyomma spp., Argas spp., Brevipalpus spp., Bryobia praetiosa, Calipitrimerus spp., Chorioptes spp., Dermanyssus gallinae, Eotetranychus carpini, Eriophyes spp., Hyalomma spp., Olygonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; and from the class Nematoda, for example, Tylenchus spp., Atylenchus spp., Anguina spp., Rotylenchus spp., Criconema spp., Tylenchulus spp., Paratylenchus spp., Aphenlenchus spp., Bursaphelenchus spp., Paralongidorus spp., Trichodorus spp., Meloidogyne spp. (for example, Meloidogyne incoginita and Meloidogyne javanica), Heterodera spp. (for example, Heterodera glycines, Heterodera schachtii, Heterodora avenae and Heterodora trifolii), Globodera spp. (for example, Globodera rostochiensis), Radopholus spp. (for example, Radopholus similes), Rotylenchulus spp., Pratylenchus spp. (for example, Pratylenchus neglectans and Pratylenchus penetrans), Aphelenchoides spp., Helicotylenchus spp., Hoplolaimus spp., Paratrichodorus spp., Longidorus spp., Nacobbus spp., Subanguina spp. Belonolaimus spp., Criconemella spp., Criconemoides spp. Ditylenchus spp., Dolichodorus spp., Hemicriconemoides spp., Hemicycliophora spp., Hirschmaniella spp., Hypsoperine spp., Macroposthonia spp., Melinius spp., Punctodera spp., Quinisulcius spp., Scutellonema spp., Xiphinema spp., and Tylenchorhynchus spp.

Each of the combinations of the invention can be formulated for a particular use. Preferably, each combination is formulated for protecting cultivated plants or their propagation materials, in particular the compositions are suitable for treatment of seeds.

Accordingly, each composition and/or combination of the invention can be applied to the plant in a conventional manner, such as seed or soil treatment. Advantageously, each of the composition and/or combinations are formulated for plant propagation material, such as seed, treatment applications for improving the growth of a plant derived from the treated material (or seed), for example, by controlling or preventing damage by pests and/or pathogens, which are found in agriculture and forestry, and can particularly damage the plant in the early stages of its development.

Further, the present invention also envisages soil application of the compositions and/or combinations of the invention to control the soil-dwelling pests and/or soil-borne pathogens. Application to the soil can be via any suitable method, which ensures that the composition and/or combination penetrates the soil, for example, nursery tray application, in furrow application, soil drenching, soil injection, drip irrigation, application through sprinklers or central pivot, incorporation into soil (broad cast or in band) or other such methods.

The benefits from the invention can also be achieved either by (i) treating plant propagation material with a composition and/or combination of the invention or (ii) applying to the locus where control is desired, generally the planting site, the composition and/or combination, or both (i) and (ii). Indeed, the benefits from the invention can also be achieved by treating plant propagation material with one or more of the ingredients of the composition or combination, and then applying to the locus where control is desired with the other ingredient(s) of the composition or combination.

The term “plant propagation material” is understood to denote all the generative parts of the plant, such as seeds, which can be used for the multiplication of the latter and vegetative plant materials such as cuttings and tubers (for example, potatoes). Accordingly, as used herein, part of a plant includes propagation material. There may be mentioned, e.g., the seeds (in the strict sense), roots, fruits, tubers, bulbs, rhizomes, parts of plants. This also applies to stem parts of gramineous crop plants such as sugar cane; in particular it also relates to stem parts having one to three nodes, preferably stems having one node such as described in WO 09/000402, for instance. Germinated plants and young plants, which are to be transplanted after germination or after emergence from the soil, are also included. These young plants may be protected before transplantation by a total or partial treatment by immersion.

Parts of plant and plant organs that grow at later point in time are any sections of a plant that develop from a plant propagation material, such as a seed. Parts of plant, plant organs, and plants can also benefit from the pest damage protection achieved by the application of each combination on to the plant propagation material. In an embodiment, certain parts of a plant and certain plant organs that grow at later point in time can also be considered as plant propagation material, which can themselves be applied (or treated) with the composition and/or combination; and consequently, the plant, further parts of the plant and further plant organs that develop from the treated parts of plant and treated plant organs can also benefit from the pest damage protection achieved by the application of each composition and/or combination on to the certain parts of plant and certain plant organs.

Methods for applying or treating pesticidal active ingredients and mixtures thereof on to plant propagation material, especially seeds, are known in the art, and include dressing, coating, pelleting and soaking application methods of the propagation material. Such methods are also applicable to the combinations according to the invention. In a preferred embodiment, the composition and/or combination is applied or treated on to the plant propagation material by a method such that the germination is not induced; generally seed soaking induces germination because the moisture content of the resulting seed is too high.

Accordingly, examples of suitable methods for applying (or treating) a plant propagation material, such as a seed, is seed dressing, seed coating or seed pelleting and alike.

It is preferred that the plant propagation material is a seed.

Although it is believed that the present method can be applied to a seed in any physiological state, it is preferred that the seed be in a sufficiently durable state that it incurs no damage during the treatment process. Typically, the seed would be a seed that had been harvested from the field; removed from the plant; and separated from any cob, stalk, outer husk, and surrounding pulp or other non-seed plant material. The seed would preferably also be biologically stable to the extent that the treatment would cause no biological damage to the seed. It is believed that the treatment can be applied to the seed at any time between harvest of the seed and sowing of the seed or during the sowing process (seed directed applications). The seed may also be primed either before or after the treatment.

Even distribution of the ingredients in the composition or combination and adherence thereof to the seeds is desired during propagation material treatment. Treatment could vary from a thin film (dressing) of the formulation containing the combination, for example, a mixture of active ingredient(s), on a plant propagation material, such as a seed, where the original size and/or shape are recognizable to an intermediary state (such as a coating) and then to a thicker film (such as pelleting with many layers of different materials (such as carriers, for example, clays; different formulations, such as of other active ingredients; polymers; and colourants) where the original shape and/or size of the seed is no longer recognisable.

An aspect of the present invention includes application of the compositions and/or combinations onto the plant propagation material in a targeted fashion, including positioning the ingredients in the combination onto the entire plant propagation material or on only parts thereof, including on only a single side or a portion of a single side. One of ordinary skill in the art would understand these application methods from the description provided in EP954213B1 and WO06112700.

The compositions and/or combinations described herein can also be used to enhance the growth of a plant through treating, or applying, a composition and/or combination according to the present on to a “pill” or a suitable substrate and placing, or sowing, the treated pill, or substrate, next to a plant propagation material . Such techniques are known in the art, particularly in EP1124414, WO07067042, and WO07067044.

Application of the compositions and/or combinations described herein onto plant propagation material also includes protecting the plant propagation material treated with the composition and/or combination of the present invention by placing one or more pesticide-containing particles next to a pesticide-treated seed, wherein the amount of pesticide is such that the pesticide-treated seed and the pesticide-containing particles together contain an

Effective Dose of the pesticide and the pesticide dose contained in the pesticide-treated seed is less than or equal to the Maximal Non-Phytotoxic Dose of the pesticide. Such techniques are known in the art, particularly in WO2005/120226.

Application of the compositions and/or combinations onto the seed also includes controlled release coatings on the seeds, wherein the ingredients of the combinations are incorporated into materials that release the ingredients over time. Examples of controlled release seed treatment technologies are generally known in the art and include polymer films, waxes, or other seed coatings, wherein the ingredients may be incorporated into the controlled release material or applied between layers of materials, or both.

Seed can be treated by applying thereto the neonicotinolid (I) and, at least one metabolic herbicide saferner (II), in any desired sequence or simultaneously.

The seed treatment occurs to an unsown seed, and the term “unsown seed” is meant to include seed at any period between the harvest of the seed and the sowing of the seed in the ground for the purpose of germination and growth of the plant.

Treatment to an unsown seed is not meant to include those practices in which the active ingredient is applied to the soil but would include any application practice that would target the seed during the planting process.

Preferably, the treatment occurs before sowing of the seed so that the sown seed has been pre-treated with the composition and/or combination. In particular, seed coating or seed pelleting are preferred in the treatment of the compositions and/or combinations according to the invention. As a result of the treatment, the ingredients in each composition and/or combination are adhered on to the seed and therefore available for pest control.

The treated seeds can be stored, handled, sowed and tilled in the same manner as any other active ingredient treated seed.

Each composition and/or combination according to the present invention is suitable for plants of the crops: cereals (such as wheat, barley, rye, triticale, oats); rice, maize (grain maize, fodder maize and sugar maize/sweet and field maize) or sorghum; beet, such as sugar or fodder beet; fruit, for example pomaceous fruit, stone fruit, tree nut or soft fruit, such as apples, pears, plums, peaches, bananas, almonds, walnuts, pistachios, cherries or berries, for example strawberries, raspberries or blackberries; leguminous crops, such as green/garden beans, lentils, peas, chickpeas, alfalfa, peanut or soy bean; oil crops, such as oilseed rape, mustard, poppies, olives, sunflowers, coconut, castor, cocoa or ground nuts; cucurbits, such as pumpkins, marrow, cucumbers or melons; fibre plants, such as cotton, flax, hemp or jute; citrus fruit, such as oranges, lemons, grapefruit or tangerines; vegetables, such as spinach, lettuce, asparagus, cabbages, iceberg, carrots, onions, tomatoes, paprika, potatoes or bell peppers; Lauraceae, such as avocado, Cinnamonium or camphor; and also tobacco, nuts, coffee, eggplants, sugarcane, tea, pepper, grapevines, hops, the plantain family, latex plants, lawn, turf, fodder grass, and ornamentals, such as petunias, geranium/pelargoniums, pansies and impatiens; and shrubs, broad-leaved trees and evergreens, such as conifers. In particular, the combination is suitable for cotton, soy bean, cereals and maize.

Each of the combinations according to the present invention are particularly suitable for use in Maize, Cereals, Rice, Oil Seeds Rape & Canola, Soybean, Cotton, Sugar Beet, Sunflower, Potato, Beans, Sorghum, Peas, Peanuts, as well as Vegetables such as Cale Crops, and Fruiting Vegetables.

The invention further pertains to the use of compositions of the invention comprising benoxacor and a neonicotinoid suitable for seed treatment to treat seeds of maize. In another embodment, compositions comprising N-(2-methoxybenzoyl)-4-[(methylaminocarbonyl)amino]benzenesulfonamide and a neonicotinoid of the invention to treat rice, cereals, maize, sorghum and turf. In a further embodiment, compositions of the invention comprising cloquintocet-mexyl are suitably used in cereals. In yet another embodiment compositions of the invention comprising cyprosulfamid are suitably used in rice, cereals, maize, sorghum and turf.

Suitable target crops also include modified crop plants of the foregoing crop types.

The wording “modified crop plants” refers to both genetically modified or transgenic crop plant as well crop plants modified through natural selection or conventional breeding. The modified crop plants used according to the invention are plants, or propagation material thereof, which are transformed by means of recombinant DNA technology in such a way that they are - for instance - capable of synthesizing selectively acting toxins as are known, for example, from toxin-producing invertebrates, especially of the phylum Arthropoda, as can be obtained from Bacillus thuringiensis strains; or as are known from plants, such as lectins; or in the alternative capable of expressing a herbicidal or fungicidal resistance. Examples of such toxins, or modified plants which are capable of synthesizing such toxins, have been disclosed, for example, in EP-A-0 374 753, WO 93/07278, WO 95/34656, EP-A-0 427 529 and EP-A-451 878 and are incorporated by reference in the present application.

Examples of modified crop plants include glyphosate tolerant crops, glufosinate tolerant crops, ACCase tolerant crops, HPPD tolerant crops, and dicamba/auxine tolerant crops, including stacked technologies

The mass ratio of of any two ingredients in each composition or combination is selected as to give the desired, for example, synergistic action. In general, the mass ratio would vary depending on the specific ingredient and how many ingredients are present in the combination. Generally, the mass ratio between any two ingredients in any composition or combination of the present invention, independently of one another, is from 100:1 to 1:100, including from 99:1, 98:2, 97:3, 96:4, 95:5, 94:6, 93:7, 92:8, 91:9, 90:10, 89:11, 88:12, 87:13, 86:14, 85:15, 84:16, 83:17, 82:18, 81:19, 80:20, 79:21, 78:22, 77:23, 76:24, 75:25, 74:26, 73:27, 72:28, 71:29, 70:30, 69:31, 68:32, 67:33, 66:34, 65:45, 64:46, 63:47, 62:48, 61:49, 60:40, 59:41, 58:42, 57:43, 56:44, 55:45, 54:46, 53:47, 52:48, 51:49, 50:50, 49:51, 48:52, 47:53, 46:54, 45:55, 44:56, 43:57, 42:58, 41:59, 40:60, 39:61, 38:62, 37:63, 36:64, 35:65, 34:66, 33:67, 32:68, 31:69, 30:70, 29:71, 28:72, 27:73, 26:74, 25:75, 24:76, 23:77, 22:78, 21:79, 20:80, 19:81, 18:82, 17:83, 16:84, 15:85, 14:86, 13:87, 12:88, 11:89, 10:90, 9:91, 8:92, 7:93, 6:94, 5:95, 4:96, 3:97, 2:98, to 1:99. Preferred mass ratios between any two components of present invention are from 75:1 to 1:75, more preferably, 50:1 to 1.50, especially 25:1 to 1:25, advantageously 10:1 to 1:10, such as 5:1 to 1:5.

In an embodiment, the ratio of (I) to (II), wherein (I) is neonicotinoid in particular thiamethoxam, and (II) is benoxacor is 75:1 to 1:75, more preferably, 50:1 to 1.50, especially 25:1 to 1:25, advantageously 10:1 to 1:10, such as 5:1 to 1:5.

In an embodiment, the ratio of (I) to (II), wherein (I) is neonicotinoid in particular thiamethoxam, and (II) is N-(2-methoxybenzoyl)-4-[(methylaminocarbonyl)amino]benzene-sulfonamide is 75:1 to 1:75, more preferably, 50:1 to 1.50, especially 25:1 to 1:25, advantageously 10:1 to 1:10, such as 5:1 to 1:5.

In an embodiment, the ratio of (I) to (II), wherein (I) is neonicotinoid in particular thiamethoxam, and (II) is cloquintocet-mexyl, is 75:1 to 1:75, more preferably, 50:1 to 1.50, especially 25:1 to 1:25, advantageously 10:1 to 1:10, such as 5:1 to 1:5.

In an embodiment, the ratio of (I) to (II), wherein (I) is neonicotinoid in particular thiamethoxam, and (II) is dichlormid, is 75:1 to 1:75, more preferably, 50:1 to 1.50, especially 25:1 to 1:25, advantageously 10:1 to 1:10, such as 5:1 to 1:5.

In an embodiment, the ratio of (I) to (II), wherein (I) is neonicotinoid in particular thiamethoxam, and (II) is cyprosulfamid, is 75:1 to 1:75, more preferably, 50:1 to 1.50, especially 25:1 to 1:25, advantageously 10:1 to 1:10, such as 5:1 to 1:5.

In an embodiment, the ratio of (I) to (II), wherein (I) is neonicotinoid in particular thiamethoxam, and (II) is fluxofenim, is 75:1 to 1:75, more preferably, 50:1 to 1.50, especially 25:1 to 1:25, advantageously 10:1 to 1:10, such as 5:1 to 1:5.

The rates of application (use) of a composition or combination vary, for example, according to type of use, type of crop, the specific agent (II) in the combination, type of plant propagation material (if appropriate), but is such that the active ingredients in the composition or combination is an effective amount to provide the desired enhanced action (such as disease or pest control) and can be determined by trials and routine experimentation known to one of ordinary skill in the art.

Generally for foliar or soil treatments, application rates can vary from 0.05 to 3 kg per hectare (g/ha) of ingredients.

Generally for seed treatments, application rates can vary from 0.5 to 1000 g/100kg of seeds of ingredients. In an embodiment, insecticide compound (I) is applied at a rate of 0.01 to 2, preferably 0.03 to 1.5, mg ai /seed, depending on the crop.

In certain embodiments it is preferable that the amount of neonicotinoid insecticide in the composition is an insecticidally effective amount, e.g. the amount of neonicotinoid insecticide (or insecticides, wherein the composition of the invention comprises more than one neonicotinoid insecticide) is such thast it is capable of killing, controlling, repelling, or infecting insects, retarding the growth or reproduction of insects, reducing an insect population, and/or reducing damage to plants caused by insects.

The plant propagation material treated by each composition or combination of the present invention can be, therefore, resistant to pest damage; accordingly, the present invention also provides a pest resistant plant propagation material which is treated with each composition or combination and consequently at least the ingredients thereof are adhered on the propagation material, such as seed.

The seed treatment combinations and compositions can also comprise or may be applied together and/or sequentially with further active compounds. These further useful active compounds can be fertilizers or micronutrient donors (such as Mo, Zn and/or Co) or other preparations that influence plant growth, such as inoculants (e.g. a strain of nitrogen-fixing bacteria), plant inducers (e.g. nod factors—see US2005187107, which hereby is herein incorporated by reference in the present application).

In a preferred embodiment of the invention, soybean seeds and transgenic soybean seeds are treated with a composition and/or combination of the present invention. In addition, the soybean seeds may be inoculated with an appropriate strain of nitrogen-fixing bacteria for the purpose of promoting plant growth. Preferably, seeds may be inoculated with an effective bacterial strain such as Rhizobium spp. or Azospirillium spp. before sowing. The primary effect of such bacteria is in the fixation of atmospheric nitrogen into a useable form for the plant. Rhizobia bacteria, for example, are especially preferred in order to form nodules on the plant roots that are sustained by the plant and in turn provide nitrogen for the plant as mentioned above.

In a further embodiment, a soybean plant propagation material is treated with a plant inducer, e.g. a nod factor derived from Bradyrhizobium japonicum, Sinorhizobium Sinorhizobium meNoti, Bradyrhizobium sp. (Arachis), or Rhizobium leguminosarum biovar phaseoli, viceae, or trifolii.

In an aspect, the present invention also envisages use of the compositions and/or combinations of the present invention with glyphosate tolerant plants, especially glyphosate tolerant soybean plants. Accordingly, the present invention provides a method comprising (a) applying a combination according to the invention as defined in the first aspect, especially those containing (II) one or more insecticides of the invention, to a glyphosate tolerant plant propagation material, preferably soybean propagation material, and (β) applying a biological organism of the invention to the resulting plant, part of plant and/or the locus thereof one or more times (i) before emergence, (ii) after emergence, or (iii) both (i) and (ii), provided that pesticide composition (B) comprises glyphosate.

Generally, glyphosate-containing composition can be applied, if applied only once, at a rate of 960 g ae/ha; if applied twice the rate can vary from 1200 to 1680 g ae/ha. The rates and number of applications vary according to the particular conditions. Preferably, the composition (B) is applied three times with an application rate of 960, 720 and 400 g ae/ha respectively.

Each of the compositions and/or combinations of the present invention may also comprise alkali metal, alkaline earth metal, metal, or ammonium salts. Zinc chloride and alkali metal, alkaline earth metal, or ammonium salts of mineral acids, especially nitrates, phosphates, sulfates, chlorides, and carbonates of sodium, potassium, ammonium, magnesium, and calcium are preferred.

Depending upon the particular plant propagation material to be treated, the conditions under which it is to be stored, and the soil and weather conditions under which it is expected to germinate and grow, the compositions and/or combinations of the present invention may include a wide spectrum of one or more additives. Such additives include, but are not limited to, uv-protectants, pigments, dyes, extenders such as flour, dispersing agents, excipients, anti-freezing agents, preservatives, herbicidal safeners, seed safeners, seed conditioners, micronutients, fertilizers, biocontrol agents, surfactants, sequestering agents, plasticizers, colorants, brighteners, emulsifiers, flow agents such as calcium stearate, talc and vermiculite, coalescing agents, defoaming agents, humectants, thickeners, waxes, bactericides, insecticides, pesticides, and fillers such as cellulose, glass fibers, clay, kaolin, talc, pulverized tree bark (e.g., Douglas fir bark or alderbark), calcium carbonate and wood meal, and odor-modifying agents. Typical excipients include finely divided mineral substances such as pumice, attapulgite, bentonite, kaoline zeolite, diatomite, and other clays, modified diatomaceous adsorbents, charcoal, vermiculite, finely divided organic substances such as peat moss, wood powder, and the like. Such additives are commercially available and known in the art.

The neonicotinoid (I) of the invention and one or more metabolic herbicide safeners (II), and optionally any other pesticides, may be used either in pure form, i.e., as a solid active ingredient, for example, in a specific particle size, or preferably together with at least one of the auxiliary (also known as adjuvants) customary in formulation technology, such as extenders, e.g., solvents or solid carriers, or surface-active compounds (surfactants), in the form of a formulation, in the present invention. Generally, the neonicotinoid (I) and one or more safeners (II) are in the form of a formulation composition with one or more of customary formulation auxiliaries.

In the event ingredients of the combinations are applied simultaneously in the present invention, they may be applied as a composition containing the combination, in which case each of (I) and (II) can be obtained from a separate formulation source and mixed together (known as a tank-mix, ready-to-apply, spray broth, or slurry), optionally with other pesticides, or (I) and (II) can be obtained as single formulation mixture source (known as a pre-mix, concentrate, formulated product), and optionally mixed together with other pesticides.

In an embodiment, each combination of the present invention is applied as a composition. Accordingly, the present invention includes a composition comprising (I) and (II), and optionally other pesticides, and optionally one or more customary formulation auxiliaries; which may be in the form of a tank-mix or pre-mix composition.

In an embodiment, each combination of (I) and (II) with one or more customary formulation auxiliaries is provided in the form of a pre-mix composition (or formulated product).

Alternative to the actual synergistic action with respect to pesticidal activity, the compositions and/or combinations according to the invention also can have surprising advantageous properties which can also be described, in a wider sense, as synergistic activity. Examples of such advantageous properties that may be mentioned are: advantageous behaviour during formulation and/or upon application, for example upon grinding, sieving, emulsifying, dissolving or dispensing; increased storage stability; improved stability to light; more advantageous degradability; improved toxicological and/or ecotoxicological behaviour; or any other advantages familiar to a person skilled in the art. In one aspect of the invention, the composition of the invention further comprises a surfactant and optionally an adhesive polymer. Whereas, examples of seed treatment formulation types for pre-mix compositions are: WS: wettable powders for seed treatment slurry; LS: solution for seed treatment; ES: emulsions for seed treatment; FS: suspension concentrate for seed treatment; WG: water dispersible granules; and CS: aqueous capsule suspension.

Examples of formulation types suitable for tank-mix compositions are solutions, dilute emulsions, suspensions, or a mixture thereof, and dusts.

As with the nature of the formulations, the methods of application, such as drench, spraying, atomizing, dusting, scattering, coating or pouring, are chosen in accordance with the intended objectives and the prevailing circumstances.

The tank-mix compositions are generally prepared by diluting with a solvent (for example, water) the one or more pre-mix compositions containing different pesticides, and optionally further auxiliaries.

Suitable carriers and adjuvants can be solid or liquid and are the substances ordinarily employed in formulation technology, e.g. natural or regenerated mineral substances, solvents, dispersants, wetting agents, tackifiers, thickeners, binders or fertilizers.

The formulations are prepared in known manner, e.g., by homogeneously mixing and/or grinding the active ingredients with extenders, e.g., solvents, solid carriers and, where appropriate, surface-active compounds (surfactants).

The composition of the invention comprises water, which serves as a suitable medium or solvent for seed treatment. Additionally, the presence of water allows for treatment of the composition onto seeds without considerably less phytotoxic damage to the plant propagation material than organic solvents. Preferably water is the predominant solvent in the composition of the invention. Generally the amount of organic solvent is less than the amount of water in the composition, preferably the amount of organic solvent is less than 5 wt %, more preferably the amount is less than 2 wt %, even more preferably the amount is less than 1 wt %, based on the total weight of the composition. Most preferred are compositions where the organic solvent is absent. Suitable examples of organic solvents include aromatic hydrocarbons, preferably the fractions containing 8 to 12 carbon atoms, e.g. xylene mixtures or substituted naphthalenes, phthalates, such as dibutyl phthalate or dioctyl phthalate, aliphatic hydrocarbons, such as cyclohexane or paraffins, alcohols and glycols and their ethers and esters, such as ethanol, ethylene glycol, ethylene glycol monomethyl or monoethyl ether, ketones, such as cyclohexanone, strongly polar solvents, such as N-methyl-2-pyrrolidone, dimethyl sulfoxide or dimethylformamide, as well as vegetable oils or epoxidised vegetable oils, such as epoxidised coconut oil or soybean oil.

The solid carriers used, e.g., for dusts and dispersible powders, are normally natural mineral fillers, such as calcite, talcum, kaolin, montmorillonite or attapulgite. In order to improve the physical properties it is also possible to add highly dispersed silicic acid or highly dispersed absorbent polymers. Suitable granulated adsorptive carriers are porous types, for example pumice, broken brick, sepiolite or bentonite, and suitable nonsorbent carriers are, for example, calcite or sand. In addition, a great number of pregranulated materials of inorganic or organic nature can be used, e.g., especially dolomite or pulverized plant residues.

Depending upon the nature of the ingredients to be formulated, suitable surface-active compounds are non-ionic, cationic and/or anionic surfactants having good emulsifying, dispersing and wetting properties. The term “surfactants” will also be understood as comprising mixtures of surfactants.

Particularly advantageous application-promoting adjuvants are also natural or synthetic phospholipids of the cephalin and lecithin series, e.g., phosphatidylethanolamine, phosphatidylserine, phosphatidylglycerol and lysolecithin.

Generally, a tank-mix formulation for foliar or soil application comprises 0.1 to 20%, especially 0.1 to 15%, of the desired ingredients, and 99.9 to 80%, especially 99.9 to 85%, of a solid or liquid auxiliaries (including, for example, a solvent such as water), where the auxiliaries can be a surfactant in an amount of 0 to 20%, especially 0.1 to 15%, based on the tank-mix formulation.

Typically, a pre-mix formulation for foliar application comprises 0.1 to 99.9%, especially 1 to 95%, of the desired ingredients, and 99.9 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

Normally, a tank-mix formulation for seed treatment application comprises 0.25 to 80%, especially 1 to 75%, of the desired ingredients, and 99.75 to 20%, especially 99 to 25%, of a solid or liquid auxiliaries (including, for example, a solvent such as water), where the auxiliaries can be a surfactant in an amount of 0 to 40%, especially 0.5 to 30%, based on the tank-mix formulation.

Typically, a pre-mix formulation for seed treatment application comprises 0.5 to 99.9%, especially 1 to 95%, of the desired ingredients, and 99.5 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

Whereas commercial products will preferably be formulated as concentrates (e.g., pre-mix composition (formulation)), the end user will normally employ dilute formulations (e.g., tank mix composition).

Preferred seed treatment pre-mix formulations are aqueous suspension concentrates. The formulation can be applied to the seeds using conventional treating techniques and machines, such as fluidized bed techniques, the roller mill method, rotostatic seed treaters, and drum coaters. Other methods, such as spouted beds may also be useful. The seeds may be presized before coating. After coating, the seeds are typically dried and then transferred to a sizing machine for sizing. Such procedures are known in the art.

In general, the pre-mix compositions of the invention contain 0.5 to 99.9 especially 1 to 95, advantageously 1 to 50 , %, by mass of the desired ingredients, and 99.5 to 0.1, especially 99 to 5, %, by mass of a solid or liquid adjuvant (including, for example, a solvent such as water), where the auxiliaries (or adjuvant) can be a surfactant in an amount of 0 to 50, especially 0.5 to 40, %, by mass based on the mass of the pre-mix formulation.

A preferred embodiment is a plant propagation material treating (or protecting) composition, wherein said plant propagation material protecting composition comprises additionally a colouring agent. The plant propagation material protecting composition or mixture may also comprise at least one polymer from water-soluble and water-dispersible film-forming polymers that improve the adherence of the active ingredients to the treated plant propagation material, which polymer generally has an average molecular weight of at least 10,000 to about 100,000.

Examples of formulations suitable for use in the invention are described below.

Powders for Dry Seed Treatment

| | a) | b) | c) |
|---|---|---|---|
| Active Ingredients | 25% | 50% | 75% |
| light mineral oil | 5% | 5% | 5% |
| highly dispersed silicic acid | 5% | 5% | — |
| Kaolin | 65% | 40% | — |
| Talcum | — | | 20 |

The combination is thoroughly mixed with the adjuvants and the mixture is thoroughly ground in a suitable mill, affording powders that can be used directly for seed treatment

Dusts

| | a) | b) | c) |
|---|---|---|---|
| Active Ingredients | 5% | 6% | 4% |
| Talcum | 95% | — | — |
| Kaolin | — | 94% | — |
| mineral filler | — | — | 96% |

Ready-for-use dusts are obtained by mixing the combination with the carrier and grinding the mixture in a suitable mill. Such powders can also be used for dry dressings for seed.

Suspension Concentrate

| | |
|---|---|
| Active Iingredients | 40% |
| propylene glycol | 10% |
| nonylphenol polyethylene glycol ether (15 mol of ethylene oxide) | 6% |
| Sodium lignosulfonate | 10% |
| carboxymethylcellulose | 1% |
| silicone oil (in the form of a 75% emulsion in water) | 1% |
| Water | 32% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

Flowable Concentrate for Seed Treatment

| | |
|---|---|
| Active ingredients | 40% |
| propylene glycol | 5% |
| Copolymer butanol PO/EO | 2% |
| Tristyrenephenole with 10-20 moles EO | 2% |
| 1,2-benzisothiazolin-3-one (in the form of a 20% | 0.5% |
| solution in water) | |
| monoazo-pigment calcium salt | 5% |
| Silicone oil (in the form of a 75% emulsion in water) | 0.2% |
| Water | 45.3% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

The invention further pertains to a product for use in agriculture or horticulture comprising a capsule wherein at least a seed treated with the composition comprising the neonicotinoid suitable for use as seed treatment selected from thiamethoxam, imidacloprid and clothianidin, and a metabolic herbicide safener is located. Alternatively, the invention pertains to a product for use in agriculture or horticulture comprising a capsule wherein at least a seed treated with the neonicotinoid suitable for use as seed treatment selected from thiamethoxam, imidacloprid and clothianidin, and a metabolic herbicide safener (or vice versa) is located. In another embodiment, the product comprises a capsule wherein at least a treated or untreated seed, a neonicotinoid suitable for use as seed treatment selected from thiamethoxam, imidacloprid and clothianidin, and a metabolic herbicide safener is located. Of the neonicotinoids used in the product thiametoxam is preferred.

Slow Release Capsule Suspension

28 parts of the composition and/or combination of active ingredients are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed. The obtained capsule suspension is stabilized by adding 0.25 parts of a thickener and 3 parts of a dispersing agent. The capsule suspension formulation contains 28% of the active ingredients. The medium capsule diameter is 8-15 microns. The resulting formulation is applied to seeds as an aqueous suspension in an apparatus suitable for that purpose.

By spraying, pouring or immersing plant propagation material with formulations such as those described above (, plant propagation material can be treated and protected against pest (e.g. pathogen) damage. Formulations of the invention as described herein may be used as formulated, or they may diluted for use.

The compostions and/or combinations according to the invention are further distinguished by the fact that they are especially well tolerated by plants and are environmentally friendly.

In an embodiment, the compositions and/or combinations according to the invention can also be used to treat stored products, such as grain, for protection against pathogens and/or pests.

Each composition and/or combination according to the invention is especially advantageous for the treatment of plant propagation material.

In a preferred embodiment, each of the compositions and/or combinations of the present invention is a plant propagation material, preferably seed, treating composition.

In each aspect and embodiment of the invention, “consisting essentially” and inflections thereof are a preferred embodiment of “comprising” and its inflections, and “consisting of” and inflections thereof are a preferred embodiment of “consisting essentially of and its inflections.

Use of a term in a singular form also encompasses that term in plural form and vice a versa.

Certain compounds defined in the first aspect are active ingredients for use in the agrochemical industry (also known as pesticides). A description of their structure as well as the structures of other pesticides (e.g., fungicides, insecticides, nematicides) can be found in the e-Pesticide Manual, version 3.1, 13th Edition, Ed. CDC Tomlin, British Crop Protection Council, 2004-05.

Various aspects and embodiments of the present invention will now be illustrated in more detail by way of example. It will be appreciated that modification of detail may be made without departing from the scope of the invention.

### EXAMPLE 1

Various batches of treated rice seeds were sown in soil contained in trays (0.0425 m²) at a rice density of 120 kg/ha and their growth monitored in a green house (at 25° C. during the day and 23° C. during the nght). The amounts of the active ingredients, i.e. thiamethoxam (Cruiser 350FS) and N-(2-methoxybenzoyl)-4-[(methylaminocarbonyl)amino]benzene-sulfonamide (safener) used for the rice seed treatment are indicated in the table below. The trays were flooded with water three days after sowing. Nine days after sowing the rice plants were sprayed with the herbicide clodinafop in an amount equal to 100 g/ha. The average plant height and the average dry shoot weight were determined five weeks after the clodinafop treatment.

The same procedure was conducted for untreated rice seeds, which did not show any living rice plants. A similar procedure was performed on untreated seeds except that the clodinafop treatment was omitted (control).

The same procedure as descrbed above was repeated except that the rice plants were treated with the herbicide clodinafop fifteen days after sowing.

The resulting average plant heights and average shoot weights are tabulated in the table below.

TABLE 2

| | | | 9 days after sowing | | 15 days after sowing | |
|---|---|---|---|---|---|---|
| | Treatment (g/ha) | | Av. plant | Av. shoot | Av. plant | Av. shoot |
| Example | Thiamethoxam | Safener | height (cm) | weight (mg) | height (cm) | weight (mg) |
| A | — | 50 | 24 | 230 | 35 | 400 |
| B | 125 | 50 | 37 | 290 | 45 | 700 |
| C | — | 100 | 30 | 300 | 40 | 510 |
| D | 125 | 100 | 52 | 400 | 48 | 710 |
| control | — | — | 53 | 800 | 50 | 710 |

From the Table it can be deduced that treatment with the safener already gives improved safening of the rice plants against the herbicide treatment over the untreated rice plants. However when the rice seeds were treated with both the safener and thiamethoxam the rice plants are safened consistently better against the herbicide treatment as is demonstrated by the higher significiantly higher average plant height and average shoot weight. This improvement is observed for different safener rates and at two different herbicide treatment times.

It is further noted that the health of the final rice plants (observed as yellowing of the leaves) were better for treatments of the safener together with thiamethoxam.

1. A composition suitable for treating seeds comprising water, a metabolic herbicide safener and a neonicotinoid selected from imidacloprid, clothianidin and thiamethoxam, wherein the total amount of herbicide safener and neonicotinoid is from 0.5 wt % and 99 wt %, based on the total weight of the composition.

2. The composition according to claim 1 wherein the herbicide safener is selected from the group consisting of AD67, BAS 145138, benoxacor, cloquintocet-mexyl, cyprosulfamide, dichlormid, fenchlorazole-ethyl, flurazole, fluxofenim, MG 191, oxabetrinil, naphthalene anhydride and N-(2-methoxybenzoyl)-4-[(methylaminocarbonyl)amino]benzene sulfonamide.

3. The composition according to claim 1 wherein the herbicide safener is selected from benoxacor, dichlromid, cyprosulfamide and fluxofenim, and N-(2-methoxybenzoyl)-4-[(methylaminocarbonyl)amino]benzenesulfonamide.

4. The composition according to claim 1 wherein the herbicide safener is benoxacor.

5. The composition according to claim 1 wherein the herbicide safener is N-(2-methoxybenzoyl)-4-[(methylaminocarbonyl)amino]benzenesulfonamide.

6. The composition according to claim 1 wherein the neonicotinoid is thiamethoxam.

7. The composition according to claim 1 wherein the composition additionally comprises water.

8. The composition according to claim 1 wherein the composition is a suspension concentrate.

9. The composition according to claim 1 wherein the composition further comprises a surfactant and optionally an adhesive polymer.

10. A method which comprises (i) treating a plant propagation material, such as a seed, with a composition according to claim 1, and (ii) planting or sowing the treated propagation material, wherein the combination protects against herbicide and/or pest damage of the treated plant propagation material, or part of plant, plant organ and/or plant grown from the treated plant propagation material.

11. The method according to claim 10 wherein the plant propagation material is a seed.

12. The method according to claim 10, further comprising the step of applying an agrochemical compound to the treated plant propagation material and/or its surroundings before or after the plant propagation material was planted or sown.

13. The method according to claim 12 wherein the agrochemical compound is a herbicide.

14. A plant propagation material treated with a composition as defined in claim 1.
